(19) United States
(12) Patent Application Publication
(10) Pub. No.: US 2018/0060368 A1
(43) Pub. Date: Mar. 1, 2018

(54) METHODS AND SYSTEMS FOR CREATING ENHANCED CONTRACT DATA RECORDS FROM MULTIPLE DISPARATE DATA SOURCES

(71) Applicant: Think Small Business, LLC, Washington, DC (US)

(72) Inventor: Olanda McCAULEY, JR., Washington, DC (US)

(21) Appl. No.: 15/692,982

(22) Filed: Aug. 31, 2017

Related U.S. Application Data
(60) Provisional application No. 62/381,869, filed on Aug. 31, 2016.

(51) Int. Cl. G06F 17/30; G06F 17/27

(52) U.S. Cl. CPC G06F 17/30303; G06F 17/30371; G06Q 50/26; G06F 17/2705; G06F 17/30882

(57) ABSTRACT

Methods and devices for creating enhanced data records from multiple disparate contract data sources may include accessing a plurality of data feeds from a plurality of websites to obtain a plurality of disparate sets of contract data relating to contract opportunities. The methods and devices may include generating according to an enhancement procedure, enhanced normalized contract data for each contract opportunity from the plurality of disparate sets of contract data, wherein the enhanced normalized contract data includes a normalized set of fields to present information relating to each contract opportunity. The methods and devices may include transmitting the enhanced normalized contract data for presentation on an interface of at least one device.

### RELATED APPLICATION

This application claims priority to U.S. Application No. 62/381,869 titled “Methods and Systems for Small Business Contracting,” filed Aug. 31, 2016, which is incorporated herein by reference in its entirety.

### BACKGROUND

It has been the policy of the federal government to provide “maximum practicable opportunity” for small businesses to participate in federal contracts. The federal government further established sub-goals for small businesses owned by women, socially and economically disadvantaged individuals, and service-disabled veterans of the Armed Forces, and for small businesses in Historically Underutilized Business Zones (HUBZones). Currently, small businesses may discover available federal contracts by accessing multiple websites where the information may be published. However, small businesses may not be able to locate all of the available opportunities across the various websites. In addition, small businesses may not discover that additional information and/or updates have occurred to published information since the websites are typically difficult to navigate and/or the information is difficult to locate.

When awarding contracts, government departments have not been able to consistently reach their small business goals. Historically HUBZone businesses are especially effected by this trend due to the majority of government departments missing their HUBZone goal. For example, the 2015 HUBZone goal was 3%; the Government achieved only 1.82%. A closer look at Fiscal Year goaling results reveals a pattern; (i) FY 2013—only 12-of-72 reporting agencies met the 3% goal; (ii) FY 2012—only 14-of-78 reporting agencies met the 3% goal; (iii) FY 2011—only 16-of-77 reporting agencies met the 3% goal; (iv) FY 2010—only 16-of-86 reporting agencies met the 3% goal. The ability to monitor goaling data in real time may improve accessibility and oversight of small business contract procurement to facilitate and increase set aside contracts, especially for HUBZone set asides. Moreover, the ability to search for small business contractors and match contract dollars to eligible small business contractors may improve government departments in reaching their small business goals.

Thus, there is a need in the art for improvements in processing contract data.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

One example implementation relates to a method of creating enhanced data records from multiple disparate contract data sources. The method may include accessing, by a processor, a plurality of data feeds from a plurality of websites to obtain a plurality of disparate sets of contract data relating to contract opportunities. The method may include generating, by the processor and according to an enhancement procedure, enhanced normalized contract data for each contract opportunity from the plurality of disparate sets of contract data, wherein the enhanced normalized contract data includes a normalized set of fields to present information relating to each contract opportunities. The method may include transmitting, by a transmitter, the enhanced normalized contract data for presentation on an interface of at least one device.

Another example implementation relates to a server. The server may include a memory to store data and instructions and a processor in communication with the memory. The server may include a data access component in communication with the memory and the processor operable to access a plurality of data feeds from a plurality of websites to obtain a plurality of disparate sets of contract data relating to contract opportunities. The server may include a parser component in communication with the memory and the processor operable to generate according to an enhancement procedure, enhanced normalized contract data for each contract opportunity from the plurality of disparate sets of contract data, wherein the enhanced normalized contract data includes a normalized set of fields to present information relating to each contract opportunity. The server may include a dashboard manager in communication with the memory and the processor operable to transmit the enhanced normalized contract data for presentation on an interface of at least one device.

Another example implementation relates to a computer-readable medium storing instructions executable by a computer device. The computer-readable medium may include at least one instruction for causing the computer device to access a plurality of data feeds from a plurality of websites to obtain a plurality of disparate sets of contract data relating to contract opportunities. The computer-readable medium may include at least one instruction for causing the computer device to generate according to an enhancement procedure, enhanced normalized contract data for each contract opportunity from the plurality of disparate sets of contract data, wherein the enhanced normalized contract data includes a normalized set of fields to present information relating to each contract opportunity. The computer-readable medium may include at least one instruction for causing the computer device to transmit the enhanced normalized contract data for presentation on an interface of at least one device.

Additional advantages and novel features relating to aspects of the present invention will be set forth in part in the description that follows, and in part will become more apparent to those skilled in the art upon examination of the following or upon learning by practice thereof.

### DESCRIPTION OF THE FIGURES

In the drawings:

FIG. 1 illustrates an example system in accordance with an implementation;

FIG. 2 is a flow diagram for an example of a method for processing contract data in accordance with an implementation;

FIGS. 3A-3H illustrate example interfaces of the dashboard in accordance with an implementation;

FIG. 4 is an example device in accordance with an implementation; and

FIG. 5 is an example sever device in accordance with an implementation.

### DETAILED DESCRIPTION

The described aspects provide resources for assisting small business contracting. The described aspects may improve small business contracting by providing a dashboard that users may access that provides a centralized location for users to view contracting opportunities. For example, small business owners may access the dashboard to view contracting information and search for contracting opportunities. Small business owners may enter search criteria and receive a result list of available contracting opportunities aggregated from a plurality of data sources. A server may retrieve new data posted for contracting opportunities from a plurality of websites and may parse the data into a computer-readable format. The parsed data may be logged into tables in a data store for easy retrieval. In addition, the parsed data may be cleaned up prior to being logged in the data store. When an update to a previously posted contract opportunity is identified, the data may be updated in the tables and a full copy of the new entry may be stored in a separate table to preserve a historic log of all information associated with the solicitations for contracts. Information, such as, North American Industry Classification System (NAICS) codes, solicitation types, and class codes associated with the contracting opportunity may be identified for all records in the table and may be matched with a human-readable equivalent so that users may easily identify contracting opportunities. In addition, when an active solicitation receives an archive update from at least one data source, the data may be removed from the active solicitations table of the data repository and transferred to an archive table.

The described aspects may also provide users with a periodic notification indicating new contracting opportunities available and/or pre-solicitations for prospective contracting opportunities. For example, users may receive an e-mail message daily that displays new contracting opportunities. Users may be able to select a contracting opportunity and may be redirected to a website where the user may apply for the selected contracting opportunity and/or receive additional information about the contracting opportunity.

The described aspects may also provide oversight of government departments small business goals and may facilitate contracts awarded to small businesses. The dashboard may provide a centralized location for users to view goaling status data for awarding contracts to small businesses. The goaling status data may be updated in real-time or near real-time so users may track the progress of government departments in achieving small business goals. In addition, users may use the dashboard to search for small business contractors and small business contracts to achieve small business goals. Users may use the dashboard to determine whether a business qualifies for various certifications (e.g., HUBZone business, women owned business, etc.). The dashboard may encourage government departments to meet small business goals by providing department goaling data, information about small business contractors qualified for the contract, facilitate communication with small business contractors, and identifying set asides for small businesses (e.g., a portion of federal contracting dollars reserved for small businesses).

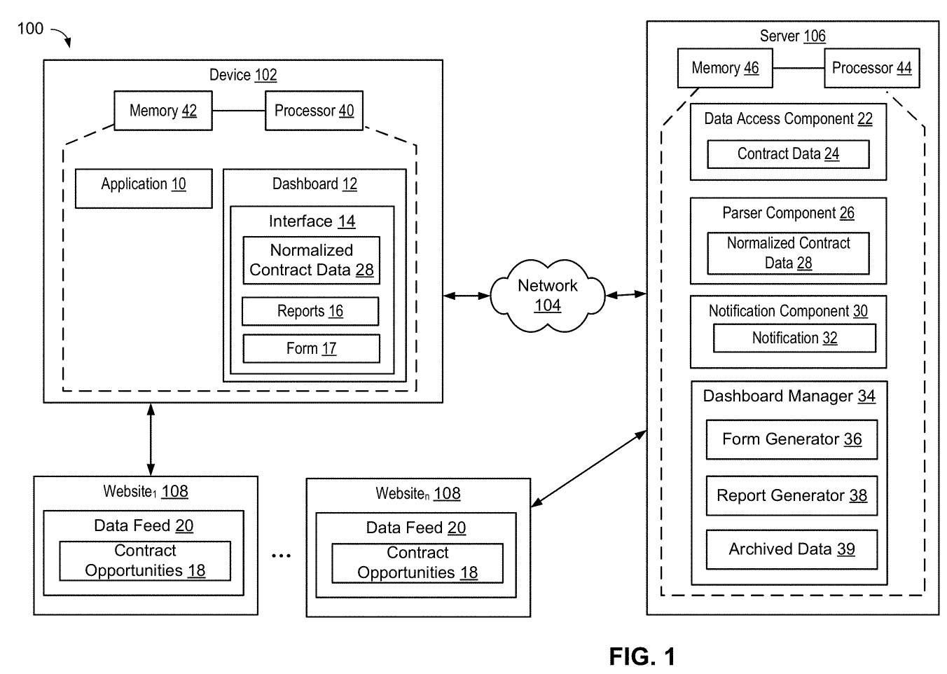

Referring now to FIG. 1, illustrated therein is an example system 100 for processing contract data in accordance with an implementation. System 100 may include one or more devices 102 communicating with one or more servers 106 via a network 104. Device 102 may include any mobile or fixed computing device, which may be connectable to network 104. Device 102 may be, for example, a computing device such as a desktop or laptop or tablet computer, a cellular telephone, a gaming device, a music device, a television, a navigation system, a camera, a personal digital assistant (PDA), or a handheld device, or any other computing device having wired and/or wireless connection capability with one or more other devices. Server/computing device 106 may include any mobile or fixed computing device connected to a network. In addition, access network 104 may provide one or more types of communication connections, such as any type of wireless airlink, to device 102 and server 106.

Devices 102 and/or servers 106 may also communicate with a plurality of websites 108 (e.g., up to n websites, where n is a positive number) to identify available contracting opportunities 18. For example, server 106 may include a data access component 22 operable to access one or more data repositories and/or data feeds 20 on the websites 108 to obtain contract data 24. Contract data 24 may include, but is not limited to, available contracting opportunities 18 with the federal government and/or pre-solicitations for upcoming contracting opportunities 18. Contract data 24 may also include information relating to, for example, registered small businesses, geographical areas (e.g., cities or states) with the most HUBZone companies, available HUBZone dollars by geographical area (e.g., states), department spending, contracts awarded, and recipients of awarded contracts. Example data feeds 20 include the Federal Procurement Data System, USA Spending, System for Award Management, and the FBOpen API. Data feeds 20 may be updated in real time or near real time as information is added relating to an existing contract opportunity 18, an existing contract opportunity 18 is removed and/or awarded, new contract opportunities 18 are added, and/or information relating to an existing contract opportunity 18 is changed. As such, data access component 22 may be able to retrieve updated information relating to contracting opportunities 18.

Server 106 may also include a parser component 26 operable to perform additional processing to the retrieved contract data 24. For example, parser component 26 may process the contract data 24 retrieved from websites 108 into a computer readable format and produce normalized contract data 28. The normalized contract data 28 may be used to aggregate the contract data 24 in a uniform manner. For example, the normalized contract data 28 may include a predetermined number of fields that may be a subset of fields included in the data feed 20 to present information relating to the contracting opportunities 18. One example use case may include using forty fields of data. Example fields of data may include, but are not limited to, a North American Industry Classification System (NAICS) code associated with the contracting opportunity 18, agency name, status of the contracting opportunity 18, SAC category, award type, agency contact information, award date, solicitation start date, solicitation end date, contract type, set aside type, and contract type. The remaining information received from the contract data 24 may not be included in the normalized contract data 28.

In addition, parser component 26 may improve the accuracy of the contract data 24 retrieved when generating the normalized contract data 28. Parser component 26 may fill in gaps in the contract data 24 received when generating the normalized contract data 28. For example, if a field is missing from the contract data 24, parser component 26 may include the information in the normalized contract data 28 when possible. Parser component 26 may also remove duplications in the contract data 24 when generating the normalized contract data 28. For example, when an update to a previously posted contracting opportunity 18 is identified, parser component 26 may update the fields of the contracting opportunity 18 without providing duplicative information for the contracting opportunity 18 in the normalized contract data 28. In addition, parser component 26 may correct any inaccuracies identified in the contract data 24. For example, when the contract data 24 is not consistent, parser component 26 may apply one or more rules to arbitrate the conflicting information identified for the contracting opportunity 18. One example use case may include the same contracting opportunity 18 listed twice with two different budgets. Parser component 26 may apply a rule that includes replacing older information with information received more recently to the contracting opportunity 18. As such, parser component 26 may take the budget received more recently for the contracting opportunity 18 and discard older budgets provided for the contracting opportunity 18 when presenting information relating to the contracting opportunity 18. Thus, as the contract data 24 is updated and/or changes, parser component 26 may continue to update the normalized contract data 28 corresponding to the contracting opportunity 18.

Parser component 26 may also generate archived data 29 from the contract data 24. For example, when an active contract opportunity 18 is awarded, the contract data 24 may be identified as archived data 29. For example, when an active solicitation receives an archive update from the data feed 20, the archived data 29 may be transferred from an active solicitation table to an archive table on server 106.

Server 106 may also include a notification component 30 operable to transmit one or more notifications 32 to users of system 100. Notification component 30 may use the normalized contract data 28 generated by parser component 26 to provide users with new contracting opportunities. Notification component 30 may generate periodic notifications 32 to users with any new contracting opportunities identified in the normalized contract data 28 and/or pre-solicitations for upcoming contracting opportunities. Notifications 32 may include, but are not limited to, an e-mail message, a text message, and a telephone call. For example, notification component 30 may generate a daily e-mail message to users with any new contracting opportunities identified in the normalized contract data 28. The e-mail message may list the contracting opportunities and users may select one or more contracting opportunities from the list. When a user select a contracting opportunity from the e-mail message, the user may be redirected to a website 108 where the user may apply for the selected contracting opportunity and/or obtain further information on the selected contracting opportunity.

Notification component 30 may tailor the notifications 32 based on user preference. For example, if a user wants to receive contracting opportunities for specific NAICS codes, notification component 30 may apply one or more filters to the normalized contract data 28 so that the user only receives contracting opportunities related to the selected NAICS codes. In addition, if a user wants to receive contracting opportunities for specific industries, notification component 30 may apply one or more filters to the normalized contract data 28 so that the user only receive contracting opportunities related to the specified industries and/or related to the industries where a user works. As such, a user who does electronic work may not receive a notice of a contract relating to building a ditch.

Server 106 may also include a dashboard manager 34 that may manage dashboard 12 and may present the normalized contract data 28 to users through dashboard 12. Dashboard manager 34 may receive user input from one or more devices 102 in communication with server 106 and may transmit the normalized contract data 28 for presentation on interface 14 based on the received user input.

Device 102 may include one or more applications 10 executed by executed or processed by processor 40 and/or system memory 42 of device 102. Applications 10 may allow a user of device 102 to access a dashboard 12 for assisting users with business contracting. Dashboard 12 may provide an interactive interface 14 that provides resources to users in achieving business contracting goals. Server 106 may include a dashboard manager 34 operable to receive user input received from dashboard 12, store data related to dashboard 12, process data received from dashboard 12, and transmit data for presentation on dashboard 12.

In an implementation, users may access dashboard 12 through a landing page. The landing page may provide restricted access to dashboard 12 and/or unrestricted access to dashboard 12. For example, the landing page may provide a button, or other icon, a user may select to access dashboard 12. The landing page may also prompt a user to enter an access code to access dashboard 12. Dashboard 12 may control user access through login credentials, such as a username and password. Moreover, dashboard 12 may be customizable based on a role of a user. Different user roles may have access to different dashboard functionalities, reporting data, and search capabilities. For example, when a user logs into dashboard 12, dashboard 12 may recognize the department the user is working for and provide relevant department goaling data to the user.

Users of dashboard 12 may include, but are not limited to, business owners, Congressional Oversight Committees, division chiefs, contracting officers, small business specialists, procurement center representatives, directors of a department, department user, small business contractors, administrators, or the public. A division chief may include, for example, an individual responsible for oversight and accountability of department small business goals and may use dashboard 12 to view, sort, filter and search dashboard 12 to find necessary information. A contracting officer may include, for example, an individual responsible for small business procurement and may use dashboard 12 to monitor goaling status, as well as performing procurement activities using form 17. A small business specialist may include, for example, an individual responsible for market research on new contracts and may assist in filling out portions of form 17, such as the proposed procurement strategy. A business owner may include small business owners.

In an implementation, a user may access dashboard 12 to search for available contracting opportunities 18 and/or view statistics on whether small business goals have been met by government departments. When the user opens dashboard 12, a list of available contract opportunities 18 may be presented to the user. For example, dashboard manager 34 may transmit the normalized contract data 28 that includes the available contract opportunities 18 for presentation on dashboard 12. Information about available contract opportunities 18 may include, but is not limited to, department name, description of the contract, posted date, set aside, response date, solicitation number, notice type, contract award date, contract award number, classification code, and NAICS code solicitation form download.

The user may filter the received normalized contract data 28 so that a subset of information may be presented. For example, a user may select specific NAICS codes from a drop down menu and/or may enter in the specific NAICS codes. Dashboard 12 may present a revised search results with the contracting opportunities 18 matching the NAICS codes. If no search results were identified, dashboard 12 may present a message indicating that no search results were identified.

Dashboard 12 may present the received search results with all the contracting opportunities matching the NAICS code. The search results may be sorted and/or further filtered based on additional preferences of the user.

Dashboard 12 may also allow users to integrate with other users through one or more social networking sites. Users may connect with other users of the system 100 to discuss different contract opportunities 18 and/or try to locate incumbent contractors to partner with. For example, users may pool resources and/or talent with other users identified through the social networking sites when preparing proposals for contracting opportunities 18.

In an implementation, dashboard 12 may provide assistance to users when applying for a contract opportunities 18. For example, dashboard 12 may provide interactive templates to assist users in applying for a contract opportunity 18. The templates may guide the users in preparing responses and/or provide users with language to include in the response. In addition, dashboard 12 may provide users with access to professionals who may be able to assist users during the application process.

In an implementation, dashboard 12 may provide information about small business contractors qualified for contracts. For example, users of dashboard 12 may be able to search for qualified small business contractors by entering in a North American Industry Classification System (NAICS) code. Dashboard 12 may transmit the entered NAICS code to dashboard manager 34 and may receive a list of small business contractors that matches the received NAICS code. Dashboard 12 may identify which small business in the result lists are a HUBZone business, a women owned business, etc. Thus, with a single search, users of dashboard 12 may easily identify small businesses qualified for the contract. Dashboard 12 may also facilitate contacting the small business contractors by providing contact information (e.g., e-mail address, telephone numbers, and corporate address) and messages to small business contractors. As such, users of dashboard 12 may easily connect with small business contractors.

Users may also use dashboard 12 to determine whether a business qualifies for various certifications (e.g., HUBZone business, women owned business, etc.). For example, a user may enter in a business address to determine whether the business is located in a HUBZone area so the business may be certified as a HUBZone business.

In an implementation, dashboard 12 may also include an interactive form 17 that may assist members of an acquisition team (e.g., contracting officer, component small business specialist, procurement center representative, director of a department, department user, and requesting office) during the procurement process to ensure that small businesses are considered when awarding a contract. In addition, form 17 may incorporate best practice features for departments to meet small business goals. Form 17 may include one or more questions/input options regarding the contract being awarded. The questions/input options may guide users through the procurement process and may promote the use of small business. For example, form 17 may require that users first contact one or more small businesses qualified for the contract before contacting other businesses.

When users of dashboard 12 access form 17, dashboard 12 may transmit a form request to dashboard manager 34. The form request may include information, such as, a department name and/or contract information. Dashboard manager 34 may interface with a form generator component 36 to generate and transmit form 17 to dashboard 12. Form generator component 36 may include one or more questions/input options for form 17. The questions/input options may be dynamic in nature so that different questions/input options populate in the small business form based on the form request information.

Users of dashboard 12 may provide responses to the questions/input options included in form 17. Responses to the questions/input options may include, for example, text entries, selecting an answer, entering a number, providing a date range, entering a “yes” or “no” response, and/or automatically populating responses based on user input. For example, once a user provides a NAICS code, the employees and average annual receipts may be automatically populated in to the small business form 17. Dashboard 12 may transmit one or more responses to the questions/input options to dashboard manager 34 and may receive updated questions/input options from dashboard manager 34 based on the responses received. As such, form 17 may be tailored to users with relevant procurement information based on the information provided.

Form 17 may record the process a government agency took during the procurement process. For example, form 17 may identify whether small businesses were contacted during the procurement process, steps a government agency took to locate a small business, and set asides. Dashboard 12 may transmit completed forms 17 to dashboard manager 34 for storage. The data from completed forms 17 may be used to update department goaling data.

Dashboard 12 may also present one or more reports 16 to a user of dashboard 12. Reports 16 may provide a simplified overview of goaling data in an easy to understand format so users may be able to easily identify goaling status for one or more departments. For example, reports 16 may easily identify whether a department missed a goal, whether a department is close to a goal, and whether a department achieved a goal. For example, reports 16 may indicate a department missed a goal when the percentage goal that a department achieved is less than 2.5% for a 3% goal and less than 4.5% for a 5% goal. In addition, reports 16 may indicate a department is close to a goal when the percentage goal that a department achieved is below 3% but above 2.5% for 3% goal, below 5% but above 4.5% for 5% goal. Reports 16 may also indicate a department achieved a goal when the percentage goal that a department achieved is at or above 3% for 3% goal, or 5% or higher for 5% goal. Color coding may be used to assist users in quickly identifying the goaling status of each department.

Goaling data presented in reports 16 may include, but is not limited to, government department name (e.g., department of defense), a number of actions and amount of dollars that are eligible for small businesses, amount of money that has been set aside for small business, the percentage of small businesses that department used in all categories, planned percentage of small businesses that each department used in all categories, the actual percentage of small businesses that each department used in all categories, total contract dollars that were given to small businesses in all categories, the percentage and dollar amount awarded to set asides with a 3% goal, the percentage of contract dollars and the total contract dollars that were given to certified HUBZone small businesses, the percentage of contract dollars that went to certified HUBZone small businesses, total contract dollars that were given to certified HUBZone small businesses, the percentage of contract dollars that went to veteran owned businesses and the total contract dollars that were given to veteran owned businesses, the percentage of contract dollars that went to veteran owned businesses, the total contract dollars that were given to veteran owned businesses, the percentage of contract dollars that went to service disabled veteran owned small businesses and the total contract dollars that were given to service disabled veteran owned small businesses, the percentage of contract dollars that went to service disabled veteran owned small businesses, the total contract dollars that were given to service disabled veteran owned small businesses, the percentage and dollar amount awarded to set asides with a 5% goal, the percentage of contract dollars that went to 8(a) businesses and the total contract dollars that were given to 8(a) businesses, the percentage of contract dollars that went to 8(a) small businesses, the total contract dollars that were given to 8(a) small businesses, the percentage of contract dollars that went to small disadvantaged businesses and the total contract dollars that were given to small disadvantaged businesses, the percentage of contract dollars that went to small disadvantaged businesses, the total contract dollars that were given to small disadvantaged businesses, the percentage of contract dollars that went to women owned small businesses and the total contract dollars that were given to women owned small businesses, the percentage of contract dollars that went to women owned small businesses, and the total contract dollars that were given to women owned small businesses.

Reports 16 may present one or more columns of goaling data. The columns may be selected by user input. For example, a user of dashboard 12 may input one or more search criteria for a report 16. Search criteria may include, but is not limited to, a department name, a start date, an end date, a fiscal year, achieved goal, missed goal, close to goal, description of the contract, posted date, set aside, response date, solicitation number, notice type, contract award date, contract award number, classification code, NAICS code. Dashboard 12 may transmit the search criteria to dashboard manager 34.

Dashboard manager 34 may receive the search criteria for report 16 and may interface with reports generator component 38. Report generator component 38 may generate one or more reports 16 based on the received search criteria. In addition, report generator component 38 may interface with data access component 22 to obtain relevant data for reports 16 based on the received search criteria. Dashboard manager 34 may transmit one or more reports 16 for display on dashboard 12.

A user may provide one or more filters to filter the goaling data presenting in report 16. In addition, a user may sort the displayed goaling data, for example, by column or rows. A user may also provide input to restrict a number of rows displayed per page. As such, reports 16 may be customizable based on user input.

In addition, reports 16 may present goaling data geographically. For example, goaling data may be visualized into a map so that users may view goaling status and small business contracts available for each state, city, and congressional district. Users may be able to zoom in and out of the map to identify a specific area of interest. The map may also be color coded so users may easily differentiate the data geographically. In an example, the map may be color coded according to the amount of spending that a geographical area provides for small businesses.

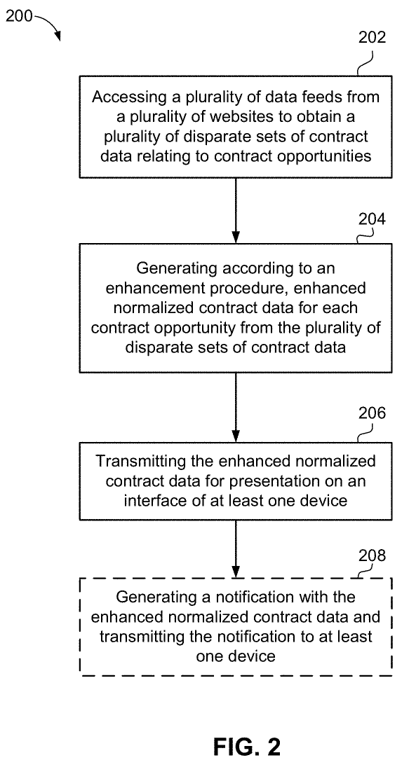

Referring now to FIG. 2, an example method 200 may be performed by server 106 (FIG. 1) to create enhanced data records from multiple disparate contract data sources, such as one or more websites 108 (FIG. 1).

At 202, method 200 may include accessing a plurality of data feeds from a plurality of websites to obtain a plurality of disparate sets of contract data relating to contract opportunities. For example, server 106 may include a data access component 22 operable to access one or more data repositories and/or data feeds 20 on the websites 108 to obtain a plurality of disparate sets of contract data 24. Contract data 24 may include, but is not limited to, available contracting opportunities 18 with the federal government and/or pre-solicitations for upcoming contracting opportunities 18. Contract data 24 may also include information relating to, for example, registered small businesses, geographical areas (e.g., cities or states) with the most HUBZone companies, available HUBZone dollars by geographical area (e.g., states), department spending, contracts awarded, and recipients of awarded contracts. As such, the plurality sets of contract data 24 retrieved may not contain the exact same fields and/or fields in the same format. Example data feeds 20 include the Federal Procurement Data System, USA Spending, System for Award Management, and the FBOpen API. Data feeds 20 may be updated in real time or near real time by the respective websites 108 as information is added relating to an existing contract opportunity, an existing contract opportunity 18 is removed and/or awarded, new contract opportunities 18 are added, and/or information relating to an existing contract opportunity 18 is changed. As such, data access component 22 may be able to retrieve updated information relating to contracting opportunities 18.

At 204, method 200 may include generating according to an enhancement procedure, enhanced normalized contract data for each contract opportunity from the plurality of disparate sets of contract data, wherein the enhanced normalized contract data. Server 106 may also include a parser component 26 operable to perform enhancement procedures to the plurality of disparate sets of contract data 24. Enhancement procedures may include, but are not limited to, formatting the plurality of disparate sets of contract data 24 into a uniform manner, improving the accuracy of the plurality of disparate sets of contract data 24, filling in fill in gaps in the plurality of disparate sets of contract data 24, and removing duplications in the plurality of disparate sets of contract data 24. For example, parser component 26 may process the plurality of disparate sets of contract data 24 retrieved from websites 108 into a computer readable format and produce enhanced normalized contract data 28. The enhanced normalized contract data 28 may be used to aggregate the contract data 24 into a uniform manner. For example, the enhanced normalized contract data 28 may include a normalized set of fields that may include a common or same set of fields for each contract opportunity. One example use case may include using forty fields of data in the normalized set of fields. Example fields of data may include, but are not limited to, a North American Industry Classification System (NAICS) code associated with the contracting opportunity 18, agency name, status of the contracting opportunity 18, SAC category, award type, agency contact information, award date, solicitation start date, solicitation end date, contract type, set aside type, and contract type. The remaining information received from the contract data 24 may not be included in the enhanced normalized contract data 28.

In addition, parser component 26 may improve the accuracy of the contract data 24 retrieved when generating the enhanced normalized contract data 28. Parser component 26 may fill in gaps in the contract data 24 received when generating the enhanced normalized contract data 28. For example, if a field is missing from the contract data 24, parser component 26 may include the information in the enhanced normalized contract data 28 when possible. Parser component 26 may also remove duplications in the contract data 24 when generating the enhanced normalized contract data 28. For example, when an update to a previously posted contracting opportunity 18 is identified, parser component 26 may update the fields of the contracting opportunity 18 without providing duplicative information for the contracting opportunity 18 in the enhanced normalized contract data 28. In addition, parser component 26 may correct any inaccuracies identified in the contract data 24. For example, when the contract data 24 is not consistent, parser component 26 may apply one or more rules to arbitrate the conflicting information identified for the contracting opportunity 18. One example use case may include the same contracting opportunity 18 listed twice with two different budgets. Parser component 26 may apply a rule that includes replacing older information with information received more recently to the contracting opportunity 18. As such, parser component 26 may take the budget received more recently for the contracting opportunity 18 and discard older budgets provided for the contracting opportunity 18. Thus, as the contract data 24 is updated and/or changes, parser component 26 may continue to update the enhanced normalized contract data 28 corresponding to the contract opportunity 18.

At 206, method 200 may include transmitting the enhanced normalized contract data for presentation on an interface of at least one device. Server 106 may also include a dashboard manager 34 that may manage dashboard 12 and may present the enhanced normalized contract data 28 to users through dashboard 12. Dashboard manager 34 may receive user input from one or more devices 102 in communication with server 106 and may transmit the enhanced normalized contract data 28 for presentation based on the received user input.

For example, a user may select specific NAICS codes from a drop down menu and/or may enter in the specific NAICS codes. Dashboard 12 may present a revised search results with the contracting opportunities 18 matching the NAICS codes. If no search results were identified, dashboard 12 may present a message indicating that no search results were identified. Dashboard 12 may present the received search results with all the contracting opportunities matching the NAICS code. The search results may be sorted and/or further filtered based on additional preferences of the user.

At 208, method 200 may optionally include generating a notification with the enhanced normalized contract data and transmitting the notification to at least one device. Server 106 may also include a notification component 30 operable to transmit one or more notifications 32 to users of system 100. Notification component 30 may use the enhanced normalized contract data 28 to provide users with new contracting opportunities. Notification component 30 may generate periodic notifications 32 to users with any new contracting opportunities identified in the enhanced normalized contract data 28 and/or pre-solicitations for upcoming contracting opportunities. Notifications 32 may include, but are not limited to, an e-mail message, a text message, and a telephone call. For example, notification component 30 may generate a daily e-mail message to users with any new contracting opportunities identified in the enhanced normalized contract data 28. The e-mail message may list the contracting opportunities and users may select one or more contracting opportunities from the list. When users select a contracting opportunity from the e-mail message, the users may be redirected to a website 108 where the users may apply for the selected contracting opportunity and/or obtain further information on the selected contracting opportunity.

Notification component 30 may filter the notifications 32 based on user preference. For example, if a user wants to receive contracting opportunities for specific NAICS codes, notification component 30 may apply one or more filters to the enhanced normalized contract data 28 so that the user only receives contracting opportunities related to the selected NAICS codes. In addition, if a user wants to receive contracting opportunities for specific industries where a user works, notification component 30 may apply one or more filters to the enhanced normalized contract data 28 so that the user only receive contracting opportunities related to the specified industries where the user works. As such, the contracting opportunities included in the notifications 32 match the users industries. For example, someone who does electronic work may not receive a notification 32 of a contract opportunities relating to building a ditch.

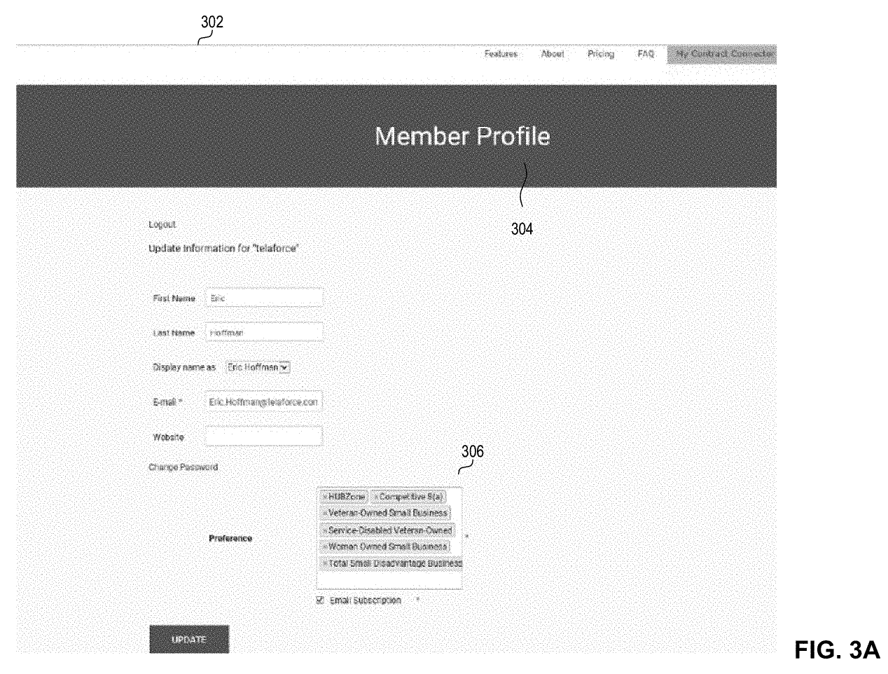

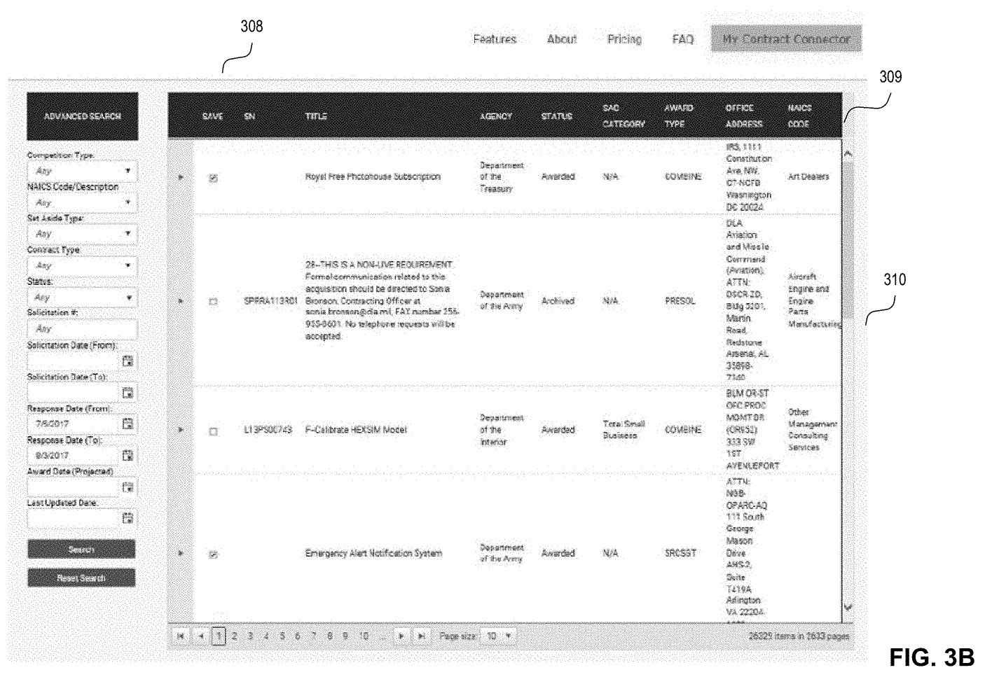

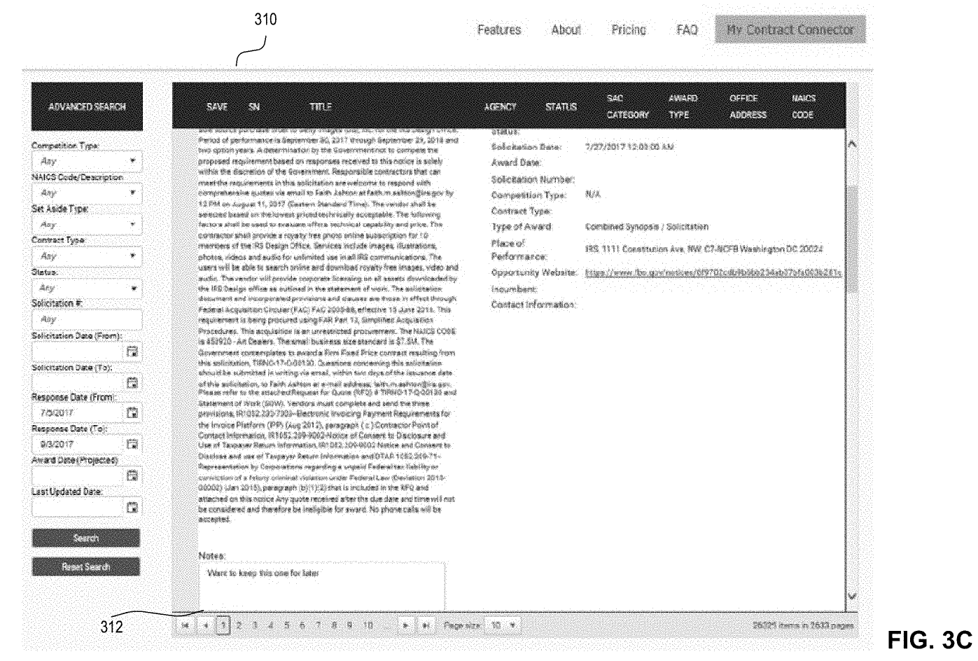

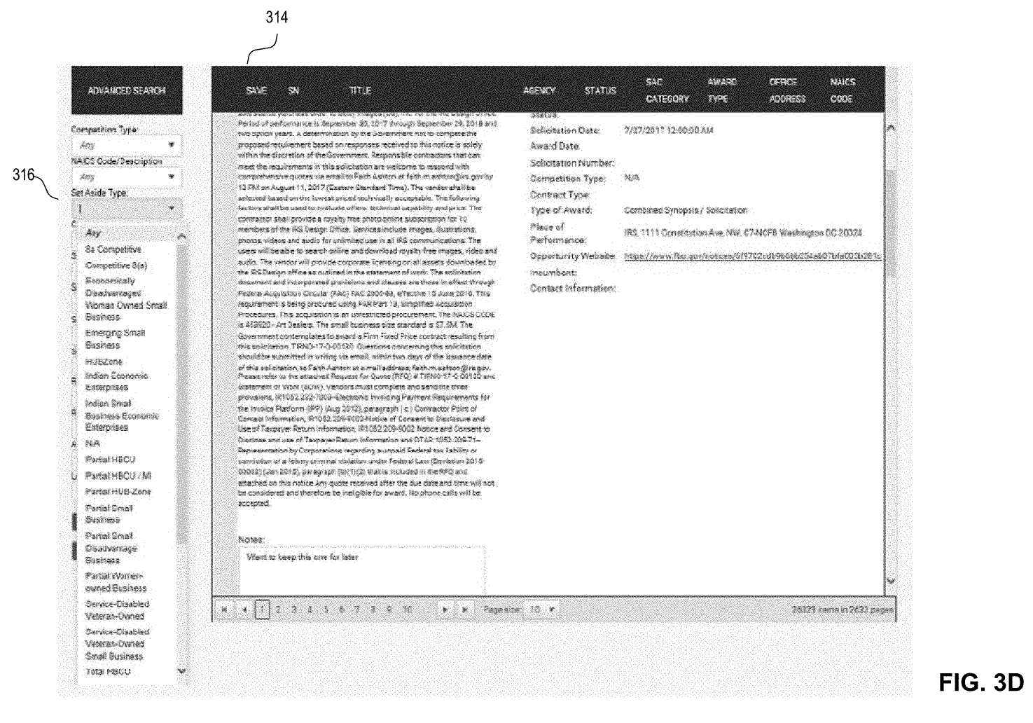

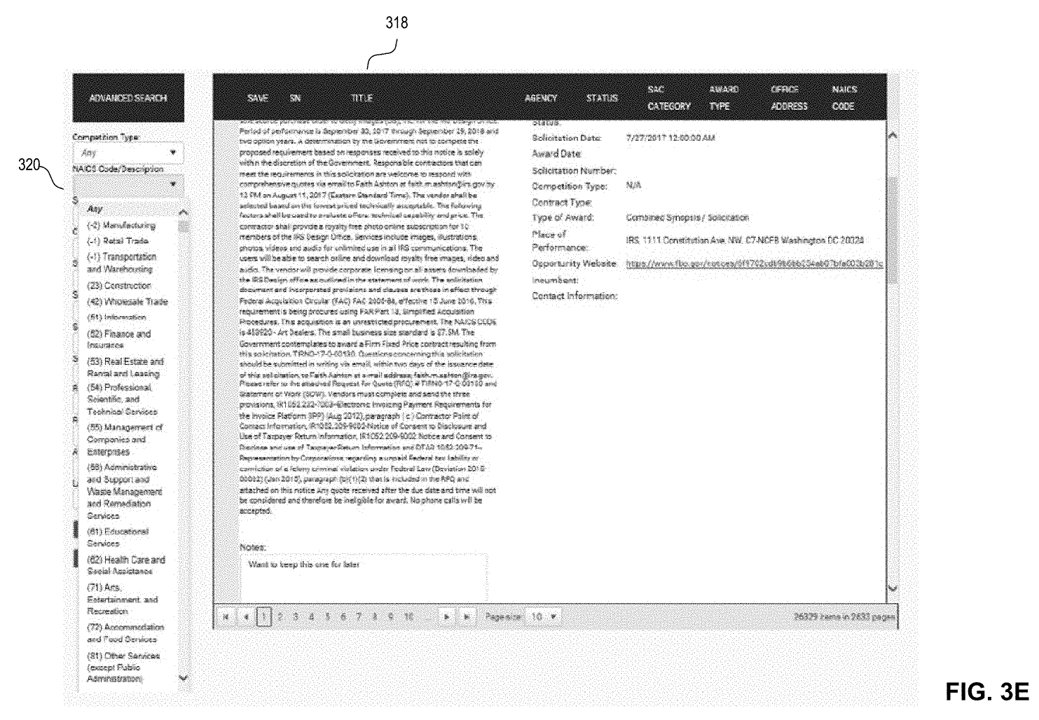

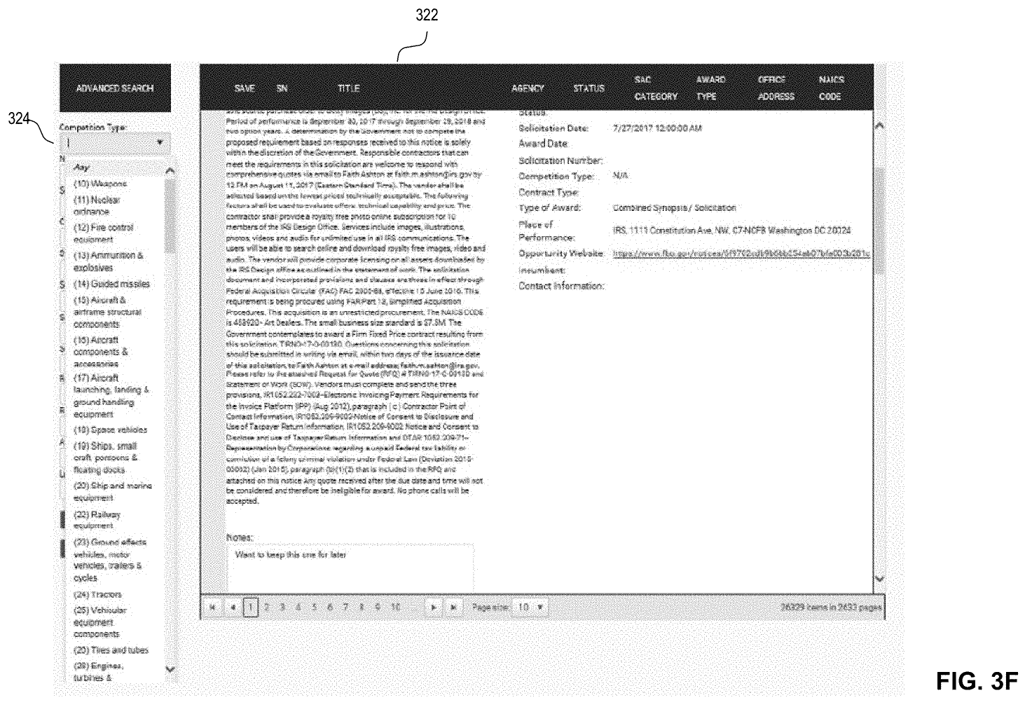

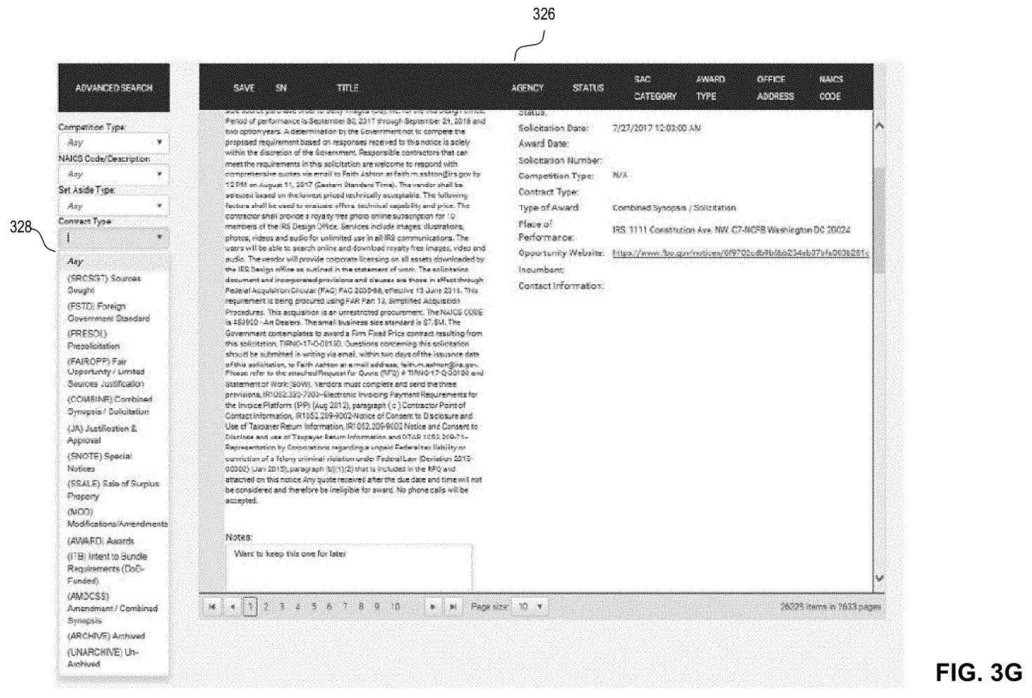

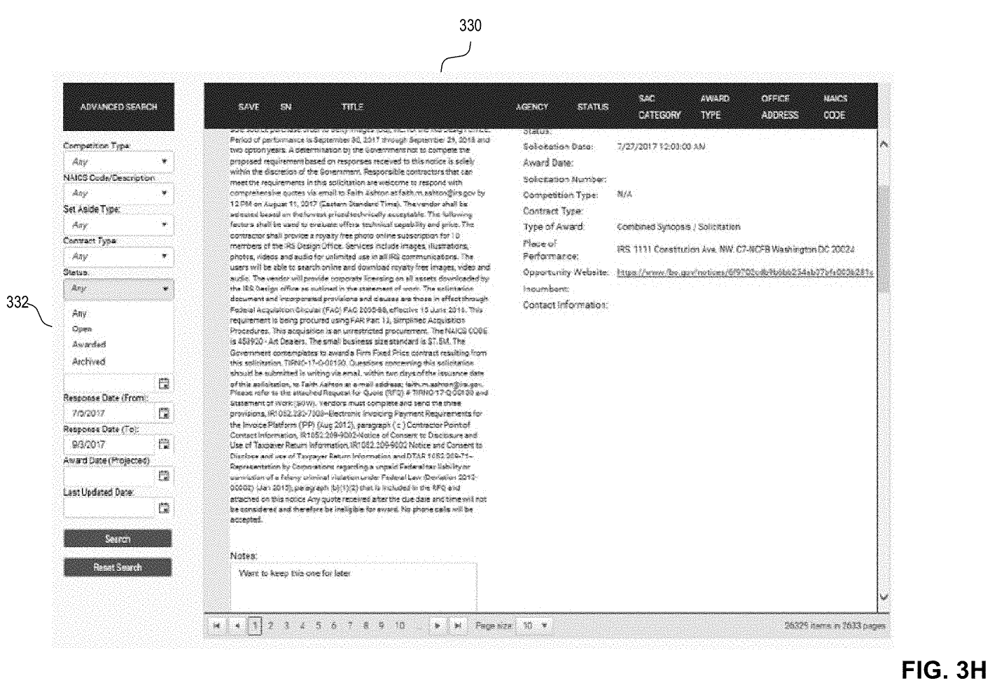

Referring now to FIGS. 3A-3H, illustrated are example graphical user interface (GUI) screens that may be presented on an interface 14 of device 102 when a user accesses dashboard 12. FIG. 3A illustrates an example screen 302 that may allow a user of dashboard 12 to update member profile information 304 for the user, such as, but not limited to, a user name, contact information, business information (e.g., NAIC codes for the user), and password information. In addition, member profile information 304 may also include user preferences 306 for information presented on interface 14 and/or received from dashboard 12. Example user preferences 306 may include, but are not limited to, selecting NAIC codes associated with contracting opportunities, subscribing to notifications of new opportunities, and identifying categories of contracting opportunities. By adding user preferences 306 to the member profile information 304, the information presented on interface 14 may be filtered and/or configured to the user preferences 306.

FIG. 3B illustrates an example screen 308 with contracting information presented to a user. Screen 308 may present a list of contracting opportunities 310 retrieved from websites 108 (FIG. 1). A plurality of fields 309 may be used to convey different information relating to the list of contracting opportunities 310. Fields 309 may include, for example, the title of the contracting opportunity, the agency posting the contracting opportunity, a status of the contracting opportunity (e.g., active or awarded), the SAC category, award type, office address, and the NAICS code associated with the contracting opportunity. Fields 309 may be customizable based on user preferences 306 and/or modified to convey different information.

FIG. 3C illustrates an example screen 310 that allows a user to provide notes 312 to associate with the contracting opportunity. Dashboard 12 may allow users to add information to different contracting opportunities by adding a new field 309 that is saved with the contracting opportunities so that users may refer back to the notes 312 when revisiting a contracting opportunity using dashboard 12.

Dashboard 12 may allow users to filter and/or search for contracting data by performing one or more searches, as illustrated in FIGS. 3D-3H. FIG. 3D illustrates an example screen 314 where a user is performing a search of the list of contracting opportunities 310. The user may, for example, search by set asides type 316. By selecting a specific set aside type 316, the list of contracting opportunities 310 presented may be narrowed down based on the selected set aside type 316. FIG. 3E illustrates an example screen 318 where a user is performing a search by NAICS codes 320. FIG. 3F illustrates an example screen 322 where a user is performing a search based on competition type 324. FIG. 3G illustrates an example screen 326 where a user is preforming a search based on contract type. In addition, FIG. 3H illustrates an example screen 330 where a user is performing a search based on the status 332 of the contract (e.g., open, awarded, and archived). As such, the user may tailor the information presented on interface 14 by performing one or more searches of the contracting data.

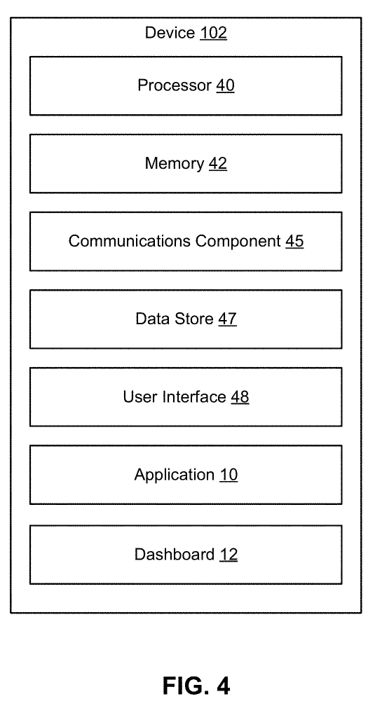

Referring now to FIG. 4, illustrated is an example device 102 in accordance with an implementation, including additional component details as compared to FIG. 1. In one aspect, device 102 may include processor 40 for carrying out processing functions associated with one or more of components and functions described herein. Processor 40 can include a single or multiple set of processors or multi-core processors. Moreover, processor 40 can be implemented as an integrated processing system and/or a distributed processing system.

Device 102 may further include memory 42, such as for storing local versions of applications being executed by processor 40. Memory 42 can include a type of memory usable by a computer, such as random access memory (RAM), read only memory (ROM), tapes, magnetic discs, optical discs, volatile memory, non-volatile memory, and any combination thereof. Additionally, processor 40 and memory 42 may include and execute applications 10 (FIG. 1) and/or dashboard 12 (FIG. 1).

Further, device 102 may include a communications component 45 that provides for establishing and maintaining communications with one or more parties utilizing hardware, software, and services as described herein. Communications component 45 may carry communications between components on device 102, as well as between device 102 and external devices, such as devices located across a communications network and/or devices serially or locally connected to device 102. For example, communications component 45 may include one or more buses, and may further include transmit chain components and receive chain components associated with a transmitter and receiver, respectively, operable for interfacing with external devices.

Additionally, device 102 may include a data store 47, which can be any suitable combination of hardware and/or software, that provides for mass storage of information, databases, and programs employed in connection with aspects described herein. Data store 47 may be a data repository for applications 10 and/or dashboard 12.

Device 102 may also include a user interface component 48 operable to receive inputs from a user of device 102 and further operable to generate outputs for presentation to the user. User interface component 48 may include one or more input devices, including but not limited to a keyboard, a number pad, a mouse, a touch-sensitive display, a navigation key, a function key, a microphone, a voice recognition component, any other mechanism capable of receiving an input from a user, or any combination thereof. Further, user interface component 48 may include one or more output devices, including but not limited to a display, a speaker, a haptic feedback mechanism, a printer, any other mechanism capable of presenting an output to a user, or any combination thereof.

Device 102 may additionally include dashboard 12 operable to provide resources to users in achieving small business contracting goals. In an implementation, user interface component 48 may transmit and/or receive messages corresponding to the operation of applications 10 and/or dashboard 12. In addition, processor 40 executes applications 10 and/or dashboard 12, and memory 42 or data store 47 may store them.

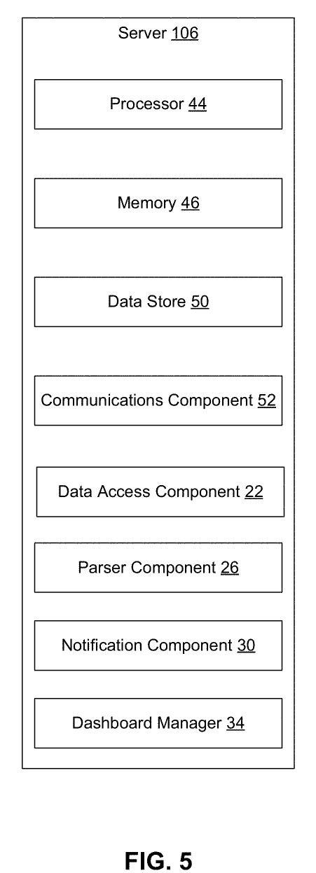

Referring now to FIG. 5, illustrated is an example sever 106 operable within the connectivity system in accordance with yet another implementation. Server 106 manages network connectivity matters for access network 104. Server 106 includes processor 44 for carrying out processing functions associated with one or more of components and functions described herein. Processor 44 can include a single or multiple set of processors or multi-core processors. Moreover, processor 44 can be implemented as an integrated processing system and/or a distributed processing system.

Server 106 further includes a memory 46, such as for storing local versions of applications being executed by processor 44. Memory 46 can include random access memory (RAM), read only memory (ROM), and a combination thereof.

Further, server 106 includes a communications component 52 that provides for establishing and maintaining communications with one or more parties utilizing hardware, software, and services as described herein. Communications component 52 may carry communications between components on server 106, as well as between server 106 and external devices, such as devices located across a communications network and/or devices serially or locally connected to server 106.

Additionally, server 106 may further include a data store 50, which can be any suitable combination of hardware and/or software, that provides for mass storage of information, databases, and programs employed in connection with aspects described herein. For example, data store 50 may be a data repository for applications not currently executing.

Server 106 may also include a data access component 22 (FIG. 1) operable to retrieve data from a plurality of sources, such as, websites 108 (FIG. 1). In addition, server 106 may include a parser component 26 (FIG. 1) operable to process the retrieved contract data and a notification component 30 (FIG. 1) operable to transmit notifications to users of the system. Server 106 may also include a dashboard manager component 34 (FIG. 1) operable to receive data from dashboard 12 (FIG. 1), store data received from dashboard 12, process data received from dashboard 12, and transmit data for presentation on dashboard 12. In an implementation, communications component 52 may transmit and/or receive messages corresponding to the operation of data access component 22, parser component 26, notification component 30 and/or dashboard manager component 34. In addition, processor 70 may execute data access component 22, parser component 26, notification component 30 and/or dashboard manager component 34, and memory 46 may store them.

As used in this application, the terms “component,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Furthermore, various aspects are described herein in connection with a device (e.g., device 102), which can be a wired device or a wireless device. A wireless device may be a cellular telephone, a satellite phone, a cordless telephone, a Session Initiation Protocol (SIP) phone, a wireless local loop (WLL) station, a personal digital assistant (PDA), a handheld device having wireless connection capability, a computing device, or other processing devices connected to a wireless modem.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

The various illustrative logics, logical blocks, and actions of methods described in connection with the embodiments disclosed herein may be implemented or performed with a specially-programmed one of a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more components operable to perform one or more of the steps and/or actions described above.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of codes and/or instructions on a machine readable medium and/or computer readable medium, which may be incorporated into a computer program product.

In one or more aspects, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave may be included in the definition of medium. Disk and disc, as used herein, includes compact disc (CD), laser disc, optical disc, digital versatile disc (DVD), floppy disk and Blu-ray disc where disks usually reproduce data magnetically, while discs usually reproduce data optically with lasers. Combinations of the above should also be included within the scope of computer-readable media.

While aspects of the present disclosure have been described in connection with examples thereof, it will be understood by those skilled in the art that variations and modifications of the aspects described above may be made without departing from the scope hereof Other aspects will be apparent to those skilled in the art from a consideration of the specification or from a practice in accordance with aspects disclosed herein.

What is claimed is:

1. A method of creating enhanced data records from multiple disparate contract data sources, comprising:
accessing, by a processor, a plurality of data feeds from a plurality of websites to obtain a plurality of disparate sets of contract data relating to contract opportunities;
generating, by the processor and according to an enhancement procedure, enhanced normalized contract data for each contract opportunity from the plurality of disparate sets of contract data, wherein the enhanced normalized contract data includes a normalized set of fields to present information relating to each contract opportunity; and
transmitting, by a transmitter, the enhanced normalized contract data for presentation on an interface of at least one device.

2. The method of claim 1, further comprising:
generating a notification with the enhanced normalized contract data, wherein the notification includes at least one available contract opportunity; and
transmitting the notification with the enhanced normalized contract data to the at least one device.

3. The method of claim 2, wherein the notification further includes at least one pre-solicitation for an upcoming contract opportunity.

4. The method of claim 2, wherein the notification further includes a link to directly access the at least one available contract opportunity on at least one of the one or more websites.

5. The method of claim 2, further comprising:
receiving at least one user preference for the notification; and
filtering the enhanced normalized contract data based on the at least one user preference.

6. The method of claim 1, further comprising:
updating the enhanced normalized contract data as new information is added to the at least one data feed.

7. The method of claim 1, wherein generating the enhanced normalized contract data further comprises removing duplicate information.

8. The method of claim 1, wherein generating the enhanced normalized contract data further comprises correcting inaccuracies identified in the plurality of disparate sets of contract data.

9. A server, comprising:
a memory to store data and instructions;
a processor in communication with the memory;
a data access component executable via the memory and the processor operable to access a plurality of data feeds from a plurality of websites to obtain a plurality of disparate sets of contract data relating to contract opportunities;
a parser component executable via the memory and the processor operable to generate according to an enhancement procedure, enhanced normalized contract data for each contract opportunity from the plurality of disparate sets of contract data, wherein the enhanced normalized contract data that includes a normalized set of fields to present information relating to each contract opportunity; and
a dashboard manager executable via the memory and the processor operable to transmit the enhanced normalized contract data for presentation on an interface of at least one device.

10. The server of claim 9, further comprising:
a notification component operable to generate a notification with the enhanced normalized contract data, wherein the notification includes at least one available contract opportunity and transmit the notification with the enhanced normalized contract data to the at least one device.

11. The server of claim 10, wherein the notification further includes at least one pre-solicitation for an upcoming contract opportunity.

12. The server of claim 10, wherein the notification further includes a link to directly access the at least one available contract opportunity on at least one of the one or more websites.

13. The server of claim 10, wherein the notification component is further operable to receive at least one user preference for the notification and filter the enhanced normalized contract data based on the at least one user preference.

14. The server of claim 9, wherein the parser component is further operable to update the enhanced normalized contract data as new information is added to the at least one data feed.

15. The server of claim 9, wherein the parser component is further operable to remove duplicate information.

16. The server of claim 9, wherein the parser component is further operable to correct inaccuracies identified in the plurality of disparate sets of contract data.

17. A computer-readable storage medium storing instructions executable by a computer device for creating enhanced data records from multiple disparate contract data sources, comprising:
at least one instruction for causing the computer device to access a plurality of data feeds from a plurality of websites to obtain a plurality of disparate sets of contract data relating to contract opportunities;
at least one instruction for causing the computer device to generate according to an enhancement procedure, enhanced normalized contract data for each contract opportunity from the plurality of disparate sets of contract data, wherein the enhanced normalized contract data includes a normalized set of fields to present information relating to each contract opportunity; and
at least one instruction for causing the computer device to transmit the enhanced normalized contract data for presentation on an interface of at least one device.
